(19) United States
(12) Patent Application Publication
(10) Pub. No.: US 2008/0149023 A1
(43) Pub. Date: Jun. 26, 2008

(54) APPARATUS AND SYSTEM USED TO APPLY CURABLE MATERIAL HAVING SELECTABLE DENSITY AND RELATED METHODS

(75) Inventor: Charles J. Torborg, Blaine, MN (US)

Correspondence Address: H.B. FULLER COMPANY, 1200 WILLOW LAKE BLVD., P.O. BOX 64683, ST. PAUL, MN, 55164-0683, US

(73) Assignee: H.B. Fuller Licensing & Financing, Inc., St. Paul, MN (US)

(21) Appl. No.: 11/961,734

(22) Filed: Dec. 20, 2007

Related U.S. Application Data
(60) Provisional application No. 60/876,399, filed on Dec. 21, 2006.

(51) Int. Cl. B05C 1/08

(52) U.S. Cl. 118/258

(57) ABSTRACT

A system for applying a curable material of a selectable density, comprising: a supply of each of one or more curable material components; a dispensing apparatus connected to each supply and comprising an outlet through which the one or more curable material components are dispensed; and a density modifying agent injection point, located upstream from the outlet, for incorporating an amount of a density modifying agent into the one or more curable material components, the amount corresponding to a selectable density of a cured product obtained from the curable material components. An apparatus for mixing and applying a curable material of a selectable density. A method of applying a curable material of a selectable density. A method including varying the density of the curable material during application thereof.

### PRIORITY

The present non-provisional patent application claims benefit from U.S. Provisional Patent Application having Ser. No. 60/876,399, filed on Dec. 21, 2006, by Torborg, and titled APPARATUS USED TO APPLY CURABLE MATERIAL HAVING SELECTABLE DENSITY AND METHODS OF USING APPARATUS, wherein the entirety of said provisional patent application is incorporated herein by reference.

### FIELD OF THE INVENTION

The present invention generally relates to an apparatus and a system for applying a curable material, particularly one having a selectable density, and related methods of use.

### BACKGROUND OF THE INVENTION

There is much prior art relating to apparatuses used to mix and apply curable materials. However, with regard to different applications of such curable materials, there may be individual needs that are not being met by existing apparatuses.

One example of such an application is the filling of voids in railroad ties using a curable material. During maintenance of a railroad right of way, rails, tie plates, and spikes are removed from railroad ties, which remain in a roadbed. Typically, only one rail at a time is removed during maintenance. After the rail is removed, a tie with empty spike holes remains. It is critical that the spike holes be repaired prior to laying new rail on the existing ties as the presence of unrepaired spike holes in the tie can cause serious problems. For example, if a spike is driven into a portion of a tie near an old spike hole, the driving force of the spike can displace the spike from its intended location into an old hole, displacing the tie plate and rail. In the instance that a spike occupies an incorrect location and a misaligned rail results, substantial expense is incurred in repairing the rail. Also, a misaligned rail is a hazard.

Another problem that can result from unrepaired spike holes in ties is that the holes can compromise the structural integrity of the tie. Additional weakness to ties may result from moisture ingress into such unplugged holes, which rots wood and accelerates degradation. Therefore, before railroad ties can be reused, spike holes need to be plugged to provide ties with structural integrity and to prevent water from accumulating within spike holes.

Mechanical hole-filling methods have been used for decades, e.g., manually driving hardwood dowels, plastic plugs or metallic inserts into holes. Some disadvantages of these methods are: first, the dowels, plugs or inserts do not completely fill a hole allowing moisture infiltration; second, if a new spike is driven into such a dowel or plug, the dowel or plug by itself cannot effectively anchor the spike; and third, the methods tend to be time-consuming, expensive and adapted to manual not automatic application.

Modern tie plugging is mostly performed using curable chemicals, e.g., urethane or epoxy-based materials. In particular, polyurethane foams have been used to fill holes and have been found to deeply infiltrate small cracks and crevices in wood in and around a spike hole. The use of such foams protects against moisture intrusion and damage by bonding tightly with wood, and by displacing standing water in tie holes during hole filling. The most commonly used curable chemical may be polyurethane because of its strength, durability, waterproof, weatherproof and UV resistance properties.

According to one representative practice, there are generally at least two densities of tie plugging compositions used in railroad tie repair: high and low density polymers. The density of the polymers may be different due to their degree of foaming, with more foam content corresponding to lower density compositions. High density polymers are used on track that has high demands placed upon it, such as track on a steep incline, on a curve, in a high speed area or in a high tonnage area. Low density polymers are generally used for track with fewer demands placed upon it, and where the strength of a high density composition is not necessary. The cost of using low density compositions is less than using high density compositions because less material is required to fill each spike hole.

The polyurethane and/or epoxy tie plugging compositions generally start from two components that commonly react to form a polyurethane and/or an epoxy polymer, as the case may be, when mixed together. When mixed, the tie plugging compositions may foam or not. Some compositions foam because a foaming agent is incorporated into the ingredients. Others foam because curing generates gaseous by-products. In some cases, multiple foaming sources may be involved.

Chemical plug material is typically supplied in two components (e.g., a resin and a curing agent, or co-reactive pre-polymer ingredients such as isocyanate functional pre-polymer and hydroxyl functional pre-polymer, or the like). The two components are generally combined immediately before application, as curing tends to occur upon mixing. Catalysts may be employed depending upon the nature of the composition being used. An operator usually walks behind a plugging machine and uses an injection gun to mix the components at the point of use and then fill a spike hole with chemical plug material dispensed from the injection gun. The material then cures to plug the hole.

A plugging machine is, typically, a self-propelled vehicle having at least one rail wheel and a non-rail wheel. Plugging machines that are based on non-self-propelled push carts are also commercially available. Plugging machines carry tanks filled with the components used to make chemical plugs and a feed pump or pumps for moving materials through the machine. Plugging machines also carry heaters, proportioned, storage drums and other equipment. The chemical components are pumped through hoses to an injection gun which, as described above, is used to insert the combined compound into spike holes. High production plugging machines used by larger railroads include equipment for two operators. The operators typically walk behind the plugging machines and fill the spike holes; however, ride-on plugging machines have also been previously disclosed (e.g., U.S. Pat. Nos. 6,598,537 and 6,832,558).

The plugging machines currently used are generally configured with a single setting to dispense one type of chemical plug in a single mode. The chemical plugs dispensed from such machines will generally have the same chemical composition and density. Therefore, a railroad company generally commits to a particular density of chemical plug. The process of changing a dispensing system to include different components is not done easily, is time-consuming, expensive and requires the presence of equipment that could handle different components. Moreover, the process requires flushing out the system each time the components are changed. Flushing the system takes time and wastes components. In addition, using two or more sets of components requires stocking and transporting the additional set of components. This is inefficient and expensive.

Because a railroad company usually commits to a particular plug density, it must balance the desired durability of the plugs with the cost. For example, the railroad company may choose to save money and use low density material along its track, even in high demand areas, or it may choose to be cautious and spend more money to use high density material along its track, even when not always necessary to meet the demands placed on all parts of the track. However, the former approach may result in a shorter life of the repaired track while the later may result in unnecessary cost.

Thus, a substantial need exists for a way to fill spike holes in railroad ties using a curable material having a selectable density, that is a density that may be changed for application to certain portions of track or even on a hole-by-hole basis.

There may be other applications for an apparatus that applies a curable material having a desired, selectable density, which were not even thought of previously. An example of one such application is using the apparatus to apply curable material to build up printing rollers to different outer diameters, while maintaining a certain inner diameter. Another such application is to form different layers of a printing roller having different densities using the same apparatus and material.

In a printing process, it is common to use printing rollers, usually cylindrical elements, in many different phases of the process. For example, printing rollers are used: to support materials that are being printed; to transfer ink; to carry ink; to press receptor material against ink; to remove excess materials, such as ink; to dry printed images; etc. Printing rollers are placed on steel mandrels. A company usually has only a few mandrels because they are expensive. In order to perform different print jobs, printing rollers having different inner and outer diameters may be used and need to fit onto steel mandrels. It would be desirable to be able to use one, or very few, sizes of steel mandrels for many printing jobs. Thus, another application in which applying a curable material with a selectable thickness is desired to apply to the outer diameter of printing rollers. This allows the outer diameter to differ while keeping the inner diameter the same. This would allow for many rollers having different outer diameters to fit on one size of steel mandrel.

Printing rollers are often comprised of multiple layers, generally with a low density inner layer and a high density outer layer. The purpose for such a configuration is for the low density material to reduce overall weight of the roller and for the high density material to provide more durability to the outer layer. Currently two separate products are applied to form the inner and outer layers. It would be desirable to be able to use one product to form both layers, which could improve efficiency and reduce expense in making rollers.

### SUMMARY OF THE INVENTION

In one aspect, the present invention relates to a system for applying a curable material of a selectable density, comprising: a supply of each of one or more curable material components; a dispensing apparatus connected to each supply and comprising an outlet through which the one or more curable material components are dispensed; and a density modifying agent injection point, located upstream from the outlet, for incorporating an amount of a density modifying agent into the one or more curable material components, the amount corresponding to a selectable density of a cured product. The dispensing apparatus may further comprise a static mixing portion, located upstream from the outlet. The injection point may be located downstream from where component A is incorporated. The injection point may be in the static mixing portion. The injection point may be in a supply line of at least one of the components of the curable material. The injection point may further comprise a nucleation tank.

In a second aspect, the present invention relates to an apparatus for mixing and applying a curable material of a selectable density comprising: a mixing housing having a mixing chamber and a mixing portion; at least one inlet for delivering one or more components of the curable material to the housing; an injection point for delivering a density modifying agent to the curable material; and an outlet for dispensing the curable material. The injection point may be in the chamber.

In a third aspect, the present invention relates to a method of applying a curable material of a selectable density comprising the steps of: providing an apparatus for applying the curable material, the apparatus comprising: a mixing chamber comprising at least one inlet and at least one outlet; and an injection point for a density modifying agent, the injection point being upstream of the outlet; introducing the curable material into the mixing chamber through the inlet; introducing the density modifying agent into the curable material; dispensing the curable material and density modifying agent from the outlet to a surface; and causing the curable material to cure. The mixing chamber may comprise at least two inlets. The mixing chamber may further comprise a static mixing portion. The curable material may comprise a component A and a component B. Component A may comprise at least one polyol and component B may comprise at least one polyisocyanate. The injection point may be located in at least one of the two inlets. The injection point may be in the mixing chamber. The injection point may comprise a nucleation tank. The density modifying agent may comprise air. The density modifying agent may comprise water. The surface may comprise a void in a railroad tie. The surface may comprise a printing roller.

In a fourth aspect, the present invention relates to a method of applying a curable material of a selectable density, including the step of varying the quantity of the density modifying agent introduced into the curable material during application thereof.

The apparatus and system of the present invention are useful whenever it is desired to apply a curable material, particularly when it is desired to adjust the density of the curable material during application. In one such application, the system and apparatus may be used to fill voids in railroad ties. Different densities of curable material may be desired along different sections of railroad track or on a hole-by-hole basis based upon demands placed on the track. For example, higher density material is desired in heavy usage areas or on turns, for example. On the other hand, lower density material is all that is necessary on light usage areas or on straight sections of track, for example. A benefit of being able to easily change the density of the curable material on a hole-by-hole basis or on portions of track is that high density and low density material may be used whenever appropriate. Using high density material is more expensive than low density because more material is used for a given volume of hole. Therefore, being able to use low density material where suitable can save a railroad company money by reducing the amount of material used. Additionally, being able to select density, as in the present invention, eliminates down time on the dispensing system that would be necessary if chemical components having different densities needed to be changed in the system.

Another exemplary application for the apparatus and system of the present invention is to apply a curable material having a selectable density to printing rollers or to sleeves placed on printing rollers. An advantage of applying curable material of a selectable density to a roller is that it allows the surface of a roller to be built up to different, desired thicknesses. Being able to build up the surface eliminates the need to have many different sizes of expensive, steel mandrels for varied uses, upon which the rollers are mounted. Additionally, being able to apply curable material of a selectable density to a roller allows for the same apparatus and material to be used to form multiple layers having different densities on the roller.

### BRIEF DESCRIPTION OF THE DRAWINGS

The above-mentioned and other advantages of the present invention, and the manner of attaining them, will become apparent and the invention itself will be better understood by reference to the following description of the embodiments of the invention taken in conjunction with the accompanying drawings, wherein like structure is referred to by like numerals throughout the figures, and wherein:

FIG. 1 is a schematic illustration of an exemplary dispensing system, for filling railroad tie voids, including a dispensing apparatus in accordance with the present invention;

FIG. 2 is a schematic cross-sectional illustration of an exemplary dispensing apparatus in accordance with the present invention;

FIG. 3 is a schematic cross-sectional illustration of an exemplary dispensing apparatus in accordance with the present invention; and

FIG. 4, is a graph titled “Nucleation Air Added vs. Volume Increases (per 100 g cured product)” and depicts results from Example 1.

### DETAILED DESCRIPTION OF PRESENTLY PREFERRED EMBODIMENTS

With reference to the accompanying figures, wherein like components are labeled with like numerals throughout the figures, a system and an apparatus for mixing and applying curable material having a selectable density are disclosed, taught and suggested by the multiple embodiments.

As used throughout the specification:

“Selectable density” means that the density of the curable material may be varied or adjusted during application so as to provide a desired density in the cured composition;

“Curable material” means a material containing one or more components that solidify from a fluid state by reacting to cause an increase in the molecular weight and/or cross-linking density of the composition; and,

“Density modifying agent” refers to an agent that, when incorporated into one or more components of a reactive composition, will cause an increase or decrease in foam content during the curing reaction, thus decreasing or increasing, respectively, the density of the cured material.

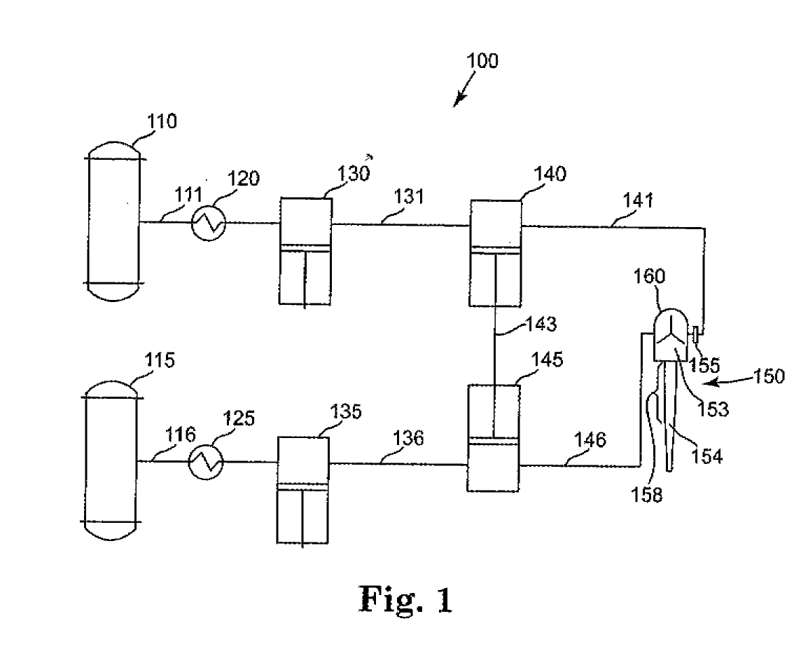

For purposes of illustration, one representative embodiment of a system 100, in accordance with the present invention, is shown in FIG. 1. The system 100 is used to apply a two-component (components A and B) curable material whose density can be varied if desired. In particular, the system 100 shown may be used for filling a void in a railroad tie with curable material.

As shown, the system 100 includes a first storage tank 110 for containing a component A, and an outlet line 111 leading from the first storage tank 110 to a first feed pump 130. The outlet line 111, and any other line in the system, may comprise a flexible hose or other suitable fluid conveying structure. A first temperature modulating device 120 (e.g., heater or cooling unit) is optionally included along the outlet line 111. The purpose of the temperature modulating device 120, and for any such device in the system 100, is to provide temperature control of any components moving through the system 100. This helps to regulate the viscosity of the components. Viscosity control aids in proper proportioning and mixing of components as well as for fluid handling and transport. The dispensing system 100 further comprises another outlet line 131 leading from the first feed pump 130 to a first proportioner 140. The first proportioner 140 can be any device that is designed to dispense a precise volume of a material. An example of one suitable proportioner is the Fixed Ratio Hydra-Cat, commercially available from Graco Inc., located in Minneapolis, Minn., U.S.A. Outlet line 141 leads from the first proportioner 140 to a dispensing apparatus 150.

The system 100 further comprises a second storage tank 115 for containing a component B and an outlet line 116 leading from the second storage lank 115 to a second feed pump 135. A second temperature modulating device 125 may also be included along the outlet line 116. Another outlet line 136 leads from the second feed pump 135 to a second proportioner 145. The second proportioner 145 may also be any device that is designed to dispense a precise volume of a material. The first and second proportioners 140, 145 may be in communication with each other, or linked to one another through some type of connecting means 143. For example, the first and second proportioners 140, 145 may be parts of an automated meter-mix application apparatus. The amounts of the components A and B may be measured out according to a specific ratio of their volumes by the proportioners 140, 145. An outlet line 146 may then lead from the second proportioner 145 to the dispensing apparatus 150.

As shown in FIG. 1, system 100 includes an exemplary dispensing apparatus 150. The outlet lines 141, 146 from the first and second proportioners 140, 145 provide the components A and B to the dispensing apparatus 150. The lines 141, 146, in particular, feed components A and B into a mixing chamber 153 of the apparatus 150. The mixing chamber 153 is a head space in the apparatus 150 where components A and B are initially mixed together. The mixing chamber 153 may be connected to a mixing portion 158 that may comprise a static mixer, but other mixing portions are also contemplated by the present invention, e.g., dynamic and impingement mixers. Preferably, the mixing portion 158 comprises baffles or elements or some similar construction for the purpose of facilitating further mixing of components A and B.

The dispensing apparatus 150 further comprises a nozzle 154 through which the mixture of the components is dispensed from the dispensing apparatus 150. Besides a nozzle, the system may alternatively include another type of dispensing outlet. The dispensing outlet may be adapted to meet the needs of the particular application.

The dispensing apparatus 150 of the present invention may further comprise a trigger (not shown). An operator of the dispensing apparatus may control the dispensing of curable material from the dispensing apparatus using the trigger. Alternatively, any other means for controlling the dispensing of the curable material is contemplated. The trigger may be provided with a time dispense feature, which allows the trigger to be actuated for a period of time in order to control the amount of material dispensed.

The dispensing apparatus 150 of the present invention may also comprise a flushing inlet (not shown). Such an inlet allows the dispensing apparatus to be flushed with a non-reactive material and prevents the mixture of components from curing inside the dispensing apparatus and clogging the apparatus. The flushing inlet is usually located upstream from the component supply lines.

At least one injection point 155 for a density modifying agent is included in the system 100. The purpose of the injection point 155 is to allow for the introduction of a density modifying agent or agents to one or more components of the curable material. The density modifying agent(s) lowers or raises the density of the curable material as desired for the particular application. The injection point 155 allows the density modifying agent to be injected directly into component A. However, the density modifying agent may instead be injected into component B or a mixture of both A and B.

A nucleation tank (not shown) may be included in the system at the injection point in order to add a gas to one of the components. If a nucleation tank is used, one possible location for the nucleation tank is along the line supplying component A to the dispensing apparatus. Preferably, a supply line goes through the nucleation tank, with the nucleation tank (including a mixer) being either turned off or on depending upon the density of curable material desired. Another possible configuration is to include a valve (e.g., a T connector including a shut-off valve) in the supply line of component A that either allows component A to enter an air nucleation tank or to bypass the nucleation tank.

In FIG. 1, the injection point 155 is shown along the line 141, and is in close proximity to the dispensing apparatus 150. A benefit of having the injection site located on or near the dispensing apparatus 150 is that when a change in density of the curable material is desired, and the density modifying agent is injected into component A or B or a mixture of both A and B, the curable material having the desired density will be more quickly dispensed from the outlet of the dispensing apparatus. Other locations for the injection point are possible, however. The injection point 155 may be located at most locations along the system 100. The particular configuration of the equipment and system may determine the most advantageous location for the injection point. Since system 100 is a representative system, if another system is used with the present inventive dispensing apparatus, other injection sites may also be possible.

The present inventive system may have multiple modes or configurations which allow for both no density modifying agent and a wide range of density modifying agent(s) to be added to the component(s) at the injection point in order to result in desired densities of curable material being dispensed from the system. In particular, curable material capable of having at least two different densities, e.g., a high density and a low density material, may be desired to be applied.

The present inventive system is not limited to the system 100 as in FIG. 1. The present invention also contemplates systems with one or more than two components making up the curable material, as well as systems including fewer or more parts than are shown in the FIG. 1 or described above. In general, the present inventive system used for applying a curable material with a selectable or desired density includes a supply or supplies of a component or components to a dispensing apparatus that mixes and dispenses the material. Additionally, if a change in density is desired, at least a portion of a density modifying agent is added to at least one of the components of me curable material at a location upstream from where the curable material is dispensed.

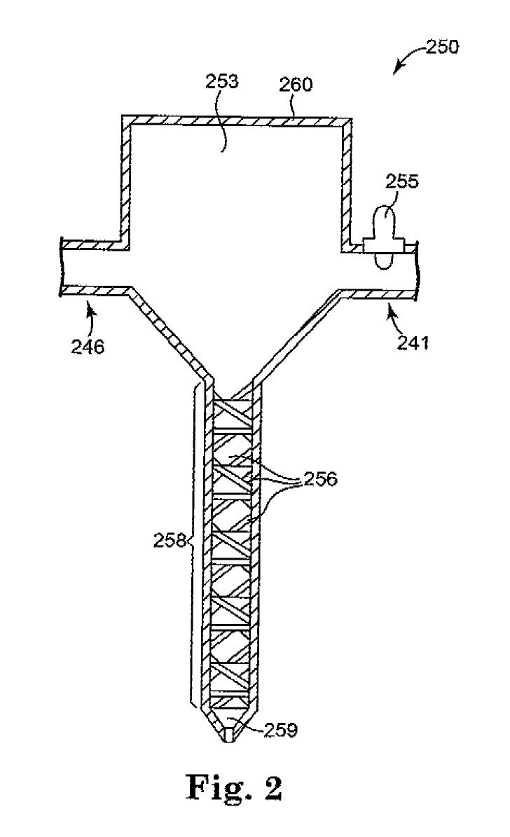

Another exemplary dispensing apparatus 250 is shown in FIG. 2, which is a schematic cross-sectional illustration. The illustrated dispensing apparatus 250 comprises a housing 260. It further comprises two inlet supply lines 241 and 246, with the first supply line 241 used to supply a component A and the second supply line 246 used to supply a component B. These supply lines are coupled to suitable supplies of components A and B (not shown) respectively. If a curable material includes more than two components, however, then additional inlet supply lines may feed into the dispensing apparatus 250. If only one component is necessary, then only one inlet supply line will be present.

The dispensing apparatus 250 also includes a mixing chamber 253. The components enter the mixing chamber 253 and move down through the dispensing apparatus 250 to a mixing portion 258 that includes baffles 256 or other elements that facilitate mixing. The mixing chamber 253 and mixing portion 258 together make up, what is referred to as, a mixing housing. Other alternative constructions that facilitate mixing of the components are also contemplated by the present invention. The mixture of the components, which is the curable material, exits the dispensing apparatus 250 through a dispensing outlet 259.

In FIG. 2, a density modifying agent injection point 255 is shown located on the first supply line 241. Alternatively, however, the injection point 255 may be located on the second supply line 246, or located along where components A and B move through the dispensing apparatus 250, prior to being dispensed.

The illustrated injection point 255 in FIG. 2 comprises a one-way valve. Alternatively, the injection point may be a one-way valve, aspiration inlet, or other means for injecting the density modifying agent into one or more of the components of the curable material.

FIG. 2 is one illustrative embodiment of the present inventive dispensing apparatus that includes a static mixer to mix components of a curable material prior to dispensing the curable material. Other types of static mixers may also be used in the present invention.

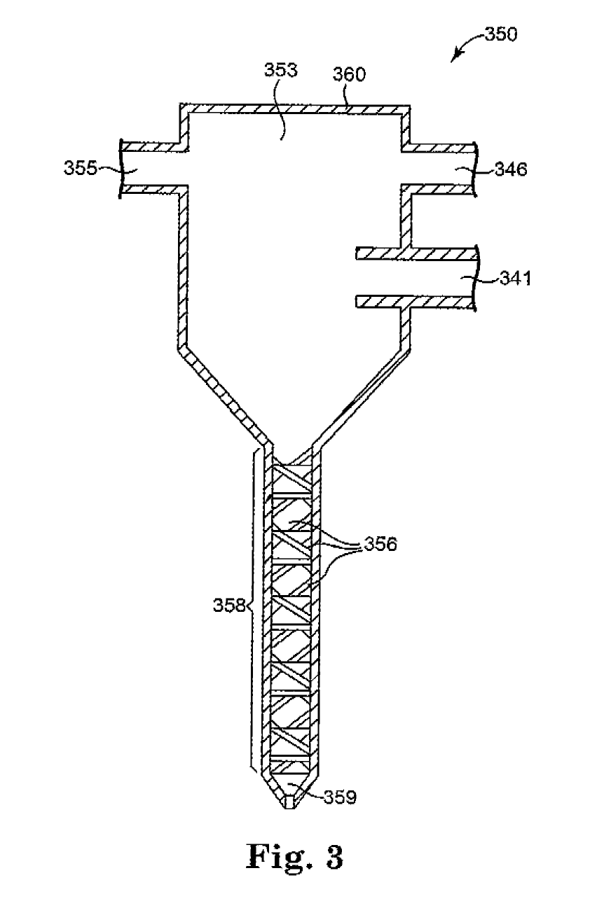

Another exemplary embodiment of the present invention is shown in FIG. 3, and comprises another type of static mixer known as an over/under injection block. The over/under injection block static mixer is typically used when there is a high ratio difference between components A and B. Dispensing apparatus 350 comprises a housing 360. As shown in FIG. 3, the first supply line 341 of the component A, which may be the component with the lower volume in the ratio of components, is placed in the stream of component B, which enters the dispensing apparatus 350 via a second supply line 346. One location for the injection point is indicated by 355. Another location for the injection point could be along the first supply line 341, or anywhere else on the mixing chamber 353, although other locations are also contemplated.

Although FIGS. 2 and 3 illustrate embodiments of the present invention that employ static mixers, other mixers, such as dynamic mixers, may also be used to mix components of a curable material with the density modifying agent prior to dispensing the curable material. Such dynamic mixers generally use high shear to fully mix the components.

The curable material that is dispensed or applied and useful with the apparatus of the present invention may be a thermoplastic, thermosetting or a physically cross-linkable material etc., having a selectable density, and that may foam and/or generate a gas. Preferably, the curable material includes more than one component, and such components are co-reactive and polymerize when combined. Preferably, the curable material is a thermosetting mixture derived from multiple components. Preferably, the components are maintained separately and mixed together at a point of use.

U.S. Pat. No. 7,138,437, which is incorporated herein by reference in its entirety, discloses an exemplary curable material (e.g., a polyurethane) formed from combining two components (components A and B). The component A, comprises at least one polyol, and the component B, comprises at least one polyisocyanate. However, other curable materials, including different components, are also contemplated by the present invention.

If the two components described in U.S. Pat. No. 7,138,437 are used in the present invention, the components A and B are preferably mixed together at a molar ratio of active hydrogen atoms from the polyol to the polyisocyanate group in a range from about 1:4 to about 4:1, preferably at a molar ratio of about 1:0.8 to about 1:4, and most preferably at a molar ratio of about 1:1 to about 1:2. Excess polyisocyanate is usually preferred because any excess isocyanate left after reaction with the polyol will react with moisture in the local environment, e.g., the air and/or the substrate. Molar ratio, as used herein, is the ratio of active hydrogen atoms in the polyol component to the isocyanate groups in the polyisocyanate component.

Exemplary density modifying agents are preferably selected from a group consisting of a gas generating agent and/or a nucleation agent. A nucleation agent, as used herein, is a gas or solid particle that, when mixed into one or more components of a reactive composition, serves as a bubble growth site for gas that is generated during a chemical reaction. A gas generating agent, as used herein, is a material that when incorporated into one or more components of a reactive composition will form a gas by decomposing or reacting with one or more components in the composition. Examples of preferred nucleating agents include, but are not limited to, air, other gases, Teflon™/sodium carbonate, silicon dioxide, wood flour and kaolin. Examples of preferred gas generating agents include, but are not limited to, water, azodicarbonamide, N,N′-Dinitrosopentamethylenetetramine, 4,4′-oxybis(benzenesulfonylhydrazide) and sodium bicarbonate/citric acid. The preferred gas generating agent may be water when polyurethane chemistry is involved. In the present invention, air may be introduced at an injection site using an air nucleator.

In the railroad tie application, usually a high or a low density curable material is desired. The curable material produced without addition of density modifying agent, or with a limited addition of density modifying agent, is generally considered to be a high density material. A “high density material” desirably is one having a density of, preferably, at least 50 lbs./ft³ (0.8 kg/dm³), more preferably between 50-70 lbs./ft³ (0.8-1.12 kg/dm³), and most preferably between 58-68 lbs./ft³ (0.928-1.09 kg/dm³). A “low density material,” which is generally curable material to which relatively more density modifying agent is added, is desirably one having a density of, preferably, lower than 50 lbs./ft³ (0.8 kg/dm³), and more preferably between 20-40 lbs./ft³ (0.32-0.64 kg/dm³). However, for applications other than railroad ties, and when different curable material components are used, other densities of curable material may be desired and selected. Additionally, there may be multiple densities desired to be chosen from in a given application, rather than just two densities.

Another aspect of the present invention is a method of applying a curable material of a desired density comprising the steps of: providing an apparatus for applying the curable material, the apparatus comprising: a mixing chamber comprising at least one inlet and at least one outlet; and an injection point for a density modifying agent, the injection point being upstream of the outlet; introducing the curable material into the mixing chamber through the inlet; introducing the density modifying agent into the curable material; dispensing the curable material and density modifying agent from the outlet to a surface; and causing the curable material to cure. The surface may comprise a void in a railroad tie or a printing roller.

The embodiments of the present invention described herein are not intended to be exhaustive or to limit the invention to the precise forms disclosed in the detailed description. Rather the embodiments are chosen and described so that others skilled in the art may appreciate and understand the principles and practices of the present invention.

The present invention will now be described with reference to the following illustrative examples.

### EXAMPLE 1

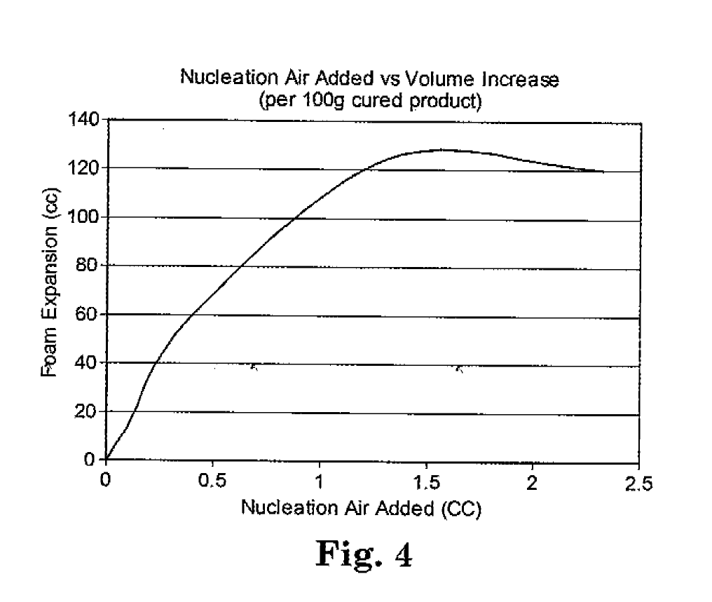

Different samples of urethanes made using a 1:1 ratio by volume of components UR2268A and UR2268B (both commercially available from H.B. Fuller Company, Vadnais Heights, Minn., U.S.A.) were prepared using polyol (UR2268A). The density of the urethanes was varied by using a Cowles mixer to add air to the polyol component. The polyol density was determined using a U.S. Standard Mini Weight per Gallon cup at 77° F. (25° C.). The cured foam density (or amount of foam expansion) was determined by dispensing each curable composition directly into an empty cup of known mass and volume at 77° F. (25° C.). FIG. 4 is a graph depicting the amount of nucleation air added using a Cowles mixer in cubic centimeters versus the amount of foam expansion in cubic centimeters that resulted in the cured material.

The results demonstrated that a small amount of nucleation air added to the polyol component resulted in a large amount of foam expansion.

The results also demonstrated that the carbon dioxide generated from the isocyanate/water reaction was a limiting factor in the maximum amount of foam expansion that occurred. Once there was enough nucleation air added to the polyol to allow substantially all of the carbon dioxide formed in the isocyanate/water reaction to diffuse out of solution, additional nucleation air did not increase foam expansion. FIG. 4 indicates that after approximately 1.5 cc of nucleation air was added, additional nucleation air did not increase foam expansion.

### EXAMPLE 2

Red oak timbers (8 inch (0.203 m) by 8 inch (0.203 m) by 4 feet (1.219 m)) were prepared by drilling ⅞-inch diameter holes into the timbers to a depth of 5 inches. Nine holes on each of two timbers were staggered at least 8 inches (0.203 m) apart. A 1:1 ratio by volume mixture of polyol and polyisocyanate was prepared in a side-by-side mix cartridge equipped with a static mix tube. The polyol composition used in the example was UR2268A (commercially available from H.B. Fuller Company, Vadnais Heights, Minn., U.S.A.). The polyisocyanate composition used in the example was UR2268B (also commercially available from H.B. Fuller Company, Vadnais Heights, Minn., U.S.A.). Air was added to certain samples using a Cowles mixer that was run for about 1 minute at 3000 rpm. The mixture was dispensed into the holes on the timbers and allowed to cure for 2 hours to form urethane plugs.

A universal testing instrument, Instron Model No. 55R4507 (commercially available from Instron, Norwood, Mass., U.S.A.) was used to determine the spike insertion and extraction forces exerted while inserting and extracting a railroad spike from each hole in the timbers. A grip on the Instron instrument was equipped with a jig capable of holding a standard ⅝-inch (0.0159 m) railroad spike in place. The Instron instrument was programmed to insert spikes into the cured urethane plugs to a depth of 5 inches (0.127 m) at a rate of 30 mm/minute. After being fully inserted and held in place for 1 minute, the spikes were extracted at a rate of 30 mm/minute. The insertion and extraction forces were continuously measured throughout the entire test. Measurements were taken from two or three spikes from each tie using each combination of polyol and polyisocyanate compositions. The force values were averaged for each combination of compositions. The densities of the plugs were also measured by dispensing some of each composition into an empty cup of known mass and volume at 77° F. (25° C.). The maximum insertion and extraction forces for the plugs, as well as the densities of the plugs, are reported in Table 1.

TABLE 1
Results of Example 2.

| | | Average | Average | |
|---|---|---|---|---|
| | | Insertion | Extraction | Density (pcf) |
| Combination of | | Force | Force | (kilograms/ |
| compositions | Air | (lbs.) | (lbs.) | cubic |
| (polyol/polyisocyanate) | added | (kg) | (kg) | meter) |
| UR2268A/UR2268B | No | 9,651 | 5,281 | 60 (961) |
| | | (4,377) | (2,395) | |
| UR2268A/UR2268B | Yes | 5,907 | 3,195 | 26 (416) |
| | | (2,679) | (1,449) | |

### EXAMPLE 3

A system 100, as shown in FIG. 1, was set up. In addition, a nucleation tank (LeGrange Products, Inc., Fremont, Ind., U.S.A., Model 0910-496) was connected to the system 100. The nucleation tank was attached to the system using a T-connector with a shut-off valve, at a location in the outlet line 111 that was located between the polyol tank 110 and the preheater 120. The shut-off valve provided the option of running die system 100 with non-nucleated polyol or with nucleated polyol that was nucleated through air pressure. The nucleation tank was filled with UR2268A (commercially available from H.B. Fuller Company, Vadnais Heights, Minn., U.S.A.). When the UR2268A was dispensed without nucleation, and mixed with UR2268B (commercially available from H.B. Fuller Company, Vadnais Heights, Minn., U.S.A.), the cured foam density of the mixture was 64 pounds/cubic foot (abbreviated “pcf”) (1,026 kilograms/cubic meter) (density was measured as described above in Example 1). The polyol was then nucleated by sparging air at 20 pounds per square inch (abbreviated “psi”) (0.138 MPa) through the nucleation tank while mixing in the tank for two minutes, with the tank being pressurized at 30 psi (0.207 MPa). The cured foam density of the nucleated mixture was 32 pcf (513 kilograms/cubic meter).

The results of Example 3 showed that the addition of nucleation air at a location close in proximity to the polyol tank resulted in a lower density foam being produced.

### EXAMPLE 4

A system 100, as shown in FIG. 1, was set up. In addition, a compressed nitrogen tank was added to the system 100 and was connected to the static mixer 153. The compressed nitrogen tank was fitted with a regulator and a line was attached to a threaded injector with an 0.016 inch (0.041 cm) orifice. The static mixer as supplied had 28 elements or baffles, and 4 elements were later removed to reduce back pressure and to provide an area for the nitrogen line to enter. A 3/32 inch (0.239 cm) hole was drilled in the static mixer in the area that had the elements removed and approximately 1.5 inches (0.038 m) from the inlet. The injector was screwed into the hole and fitted with the nitrogen line. The nitrogen line was glued to the injector with an epoxy adhesive.

The configuration of the system in the Example allowed compressed nitrogen to continue to flow into the static mixer during the testing period.

UR2668A and B (both commercially available from H.B. Fuller Company, Vadnais Heights, Minn., U.S.A.) were mixed in and dispensed through the static mixer while the compressed nitrogen was delivered to the static mixer. The mixture was dispensed at the outlet into cups in order to measure the density of the cured foam (as described in Example 1). First, four separate tests were carried out with varying nitrogen pressure from 0 psi (0 MPa) (off) to 150 psi (1.03 MPa), in which the gun trigger was pressed and the mixture was released from the outlet and dispensed into cups. Three samples were collected from the outlet with each tested nitrogen pressure (0, 100, 120 and 150 psi) (0, 0.69 MPa, 0.827 MPa, and 1.03 MPa). The results are summarized in Table 2 below.

TABLE 2
Results of Nitrogen Injection into Static Mixer-Trigger Pressed &
Released

| | Cured Density |
|---|---|
| Nitrogen Pressure | (Avg. of 3 trials) (pcf) |
| (psi) (MPa) | (kg/m³) |
| 0 (0) | 65 (1041) |
| 100 (0.69) | 59 (945) |
| 120 (0.827) | 57 (913) |
| 150 (1.03) | 50 (800) |

The results in Table 2 showed a decrease in density with an increase in nitrogen pressure. However, the trigger to release the mixture from the static mixer was pressed to collect samples and was then released between collections.

Second, three separate tests were carried out varying the nitrogen pressure from 0 psi (off) to 180 psi (1.24 MPa), in which the gun trigger was left open or depressed. The results are summarized in Table 3 below.

TABLE 3
Results of Nitrogen Injection into Static Mixer-Trigger Not Released

| | Trial 1 | Trial 2 | Trial 3 | Trial 4 | Average |
|---|---|---|---|---|---|
| Nitrogen Pressure | Density in | Density in | Density in | Density in | Density in |
| (psi) (MPa) | pcf (kg/m³) | pcf (kg/m³) | pcf (kg/m³) | pcf (kg/m³) | pcf (kg/m³) |
| 0 (0) | 70 (1121) | 67 (1073) | 70 (1121) | 66 (1057) | 68 (1089) |
| 130 (0.896) | 70 (1121) | 66 (1057) | 68 (1089) | 66 (1057) | 68 (1089) |
| 180 (1.24) | 55 (881) | 24 (384) | 44 (704) | 28 (449) | 38 (609) |

The results in Table 3 show that there was a reduction in the density of the cured foam when compressed nitrogen having a pressure of 180 psi (1.24 MPa) was added to the static mixer. The nitrogen pressure of 130 psi (0.896 MPa) did not, on average, change the density. The trigger was continuously depressed while the samples were taken and in between samples being taken, so the mixture was continuously fed through the static mixer.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

What is claimed is:

1. A system for applying a curable material of a selectable density, comprising:
a supply of each of one or more curable material components;
a dispensing apparatus connected to each supply and comprising an outlet through which the one or more curable material components are dispensed; and
a density modifying agent injection point, located upstream from the outlet, for incorporating an amount of a density modifying agent into the one or more curable material components, the amount corresponding to a selectable density of a cured product obtained from the curable material components.

2. The system of claim 1, wherein the dispensing apparatus further comprises a static mixing portion, located upstream from the outlet.

3. The system of claim 1, wherein the injection point is located downstream from the supply of one or more curable material components.

4. The system of claim 2, wherein the injection point is in the static mixing portion.

5. The system of claim 2, wherein the injection point is in a supply line of at least one of the components of the curable material.

6. The system of claim 1, wherein the injection point further comprises a nucleation tank.

7. An apparatus for mixing and applying a curable material of a selectable density comprising:
a mixing housing having a mixing chamber and a mixing portion;
at least one inlet for delivering one or more components of the curable material to the housing;
an injection point for delivering a density modifying agent to the curable material; and
an outlet for dispensing the curable material.

8. The apparatus of claim 7, wherein the injection point is in the mixing chamber.

9. A method of applying a curable material of a selectable density comprising the steps of:
providing an apparatus for applying the curable material, the apparatus comprising:
a mixing chamber comprising at least one inlet and at least one outlet; and
an injection point for a density modifying agent, the injection point being upstream of the outlet;
introducing the curable material into the mixing chamber through the inlet;
introducing the density modifying agent into the curable material;
dispensing the curable material and density modifying agent from the outlet to a surface; and
causing the curable material to cure.

10. The method of claim 9, wherein the mixing chamber comprises at least two inlets.

11. The method of claim 10, wherein the mixing chamber further comprises a static mixing portion.

12. The method of claim 11, wherein the curable material comprises a component A and a component B.

13. The method of claim 12, wherein component A comprises at least one polyol and component B comprises at least one polyisocyanate.

14. The method of claim 10, wherein the injection point is located in at least one of the two inlets.

15. The method of claim 10, wherein the injection point is in the mixing chamber.

16. The method of claim 10, wherein the injection point comprises a nucleation tank.

17. The method of claim 9, wherein the density modifying agent comprises air.

18. The method of claim 9, wherein the density modifying agent comprises water.

19. The method of claim 9, wherein the surface comprises a void in a railroad tie.

20. The method of claim 9, wherein the surface comprises a printing roller.

21. The method of claim 9, comprising the further step of varying the quantity of density modifying agent introduced into the curable material during application thereof.
